(19) United States
(12) Patent Application Publication
(10) Pub. No.: US 2018/0111403 A1
(43) Pub. Date: Apr. 26, 2018

(54) MAGICAL GREETING CARD SYSTEM

(71) Applicants: Omead Ghasri, Irvine, CA (US); Rudy Sanchez, Irvine, CA (US)

(72) Inventors: Omead Ghasri, Irvine, CA (US); Rudy Sanchez, Irvine, CA (US)

(21) Appl. No.: 15/335,084

(22) Filed: Oct. 26, 2016

(51) Int. Cl. B42D 15/02; B42D 15/04

(52) U.S. Cl. CPC B42D 15/022; B42D 15/04

(57) ABSTRACT

An interactive greeting card system to amaze the recipients is disclosed. The greeting card system comprises a planar sheet body of pre-defined shape comprising a first covering member and a second covering member fixedly attached to each other at their confronting ends, wherein the first covering member is configured to display a plurality of illustrated artwork from outside. The first covering member defines a concealed section which further comprises a plurality of audio files is operably embedded in a microcontroller in the concealed section to selectively play at least one audio file via an inbuilt speaker and a plurality of switches is configured to selectively activate the microcontroller in the concealed section of the second covering member to play a sequence in relation with the predetermined illustrative artwork on the second covering member whenever a user opens the greeting card.

### BACKGROUND

For ages, people have been using greeting cards to share their emotions and feelings to their peers. There are varieties of greeting cards available in the market to mark various occasions such as marriages, birthdays and so on to greet people. They are generally enclosed inside an envelope and given to their recipients. Traditional and seasonal greeting cards have been used to convey some universal messages to their recipients. But in the recent times, the use of these cards have been significantly reduced as they are not interactive and appealing to most people. Some envelopes also were made to be interactive instead of the card in order to get the recipients interest.

Previous attempts have been made to provide greeting cards that are more interactive and entertaining by using a sound module in the card to give the recipient a new experience when they open the card. In some cases, some cards use illustrated artwork that may look appealing to the people. However, these kind of cards have their own limitations like the recipient gets bored of the repeated in-built sound and same set of artworks, and its lack of surprises and so on. Then, some of the previous attempts were aimed at the greeting cards that comprises both the sound module and the illustrated artwork so that the recipient can feel the trick. However, when they started hearing and seeing the same message repeatedly, the recipients lost their interest in these cards.

Prior art reference U.S. Pat. No. 8,272,154 B2 discloses a flip book greeting card having an outside cover containing text and artwork and an inside panel containing a flip book and it has one image that moves in motion. However, it does not include any audio file to make the session interactive.

Prior art reference U.S. Pat. No. 8,850,726B2 discloses a motion greeting card having one or more moving elements and functions which create motion. It contains a sound module and a motor module. However, this has only one audio file and plays the same message repeatedly when the card is opened and therefore fails to keep the recipient interactive and interested.

In light of the aforementioned drawbacks and limitations, there exists a need for a greeting card system that is appealing and that which provides magical tricks to the recipients to make it interactive.

### SUMMARY

The objective of the present invention is to provide a greeting card system that is interactive and amazes the recipients with magical tricks by playing a plurality of audio files in relation with an illustrated artwork.

According to one embodiment of the present invention, the greeting card system comprises a planar sheet body of pre-defined shape comprising a first covering member and a second covering member fixedly attached to each other at their confronting ends, wherein the first covering member is configured to provide a scope for communicating a personalized message to the recipient. The second covering member defines a concealed section comprising a plurality of audio files is operably embedded in a microcontroller in the concealed section to selectively play at least one audio file via an inbuilt speaker.

According to preferred embodiment of the present invention, the greeting card system comprises a plurality of switches that are configured to selectively activate the microcontroller in the concealed section of the second covering member to play a sequence in relation with the predetermined illustrated artwork on the second covering member when a user opens the greeting card.

### BRIEF DESCRIPTIONS OF SEVERAL VIEWS OF DRAWINGS

FIG. 1 illustrates a perspective view of a greeting card system, according to an embodiment of the present invention.

FIG. 2 illustrates the perspective view of the greeting card system showing a plurality of switches embedded on the second covering, according to an embodiment of the present invention.

FIG. 3 illustrates a rear side of the second covering member of the greeting card system, according to an embodiment of the present invention.

### DETAILED DESCRIPTION OF DIFFERENT EMBODIMENTS

The present invention is related to a greeting card system 100 which comprises a plurality of greeting cards to amazes the recipients with magical tricks by playing a plurality of audio files in relation with an illustrated artwork 112 depicted in the greeting card.

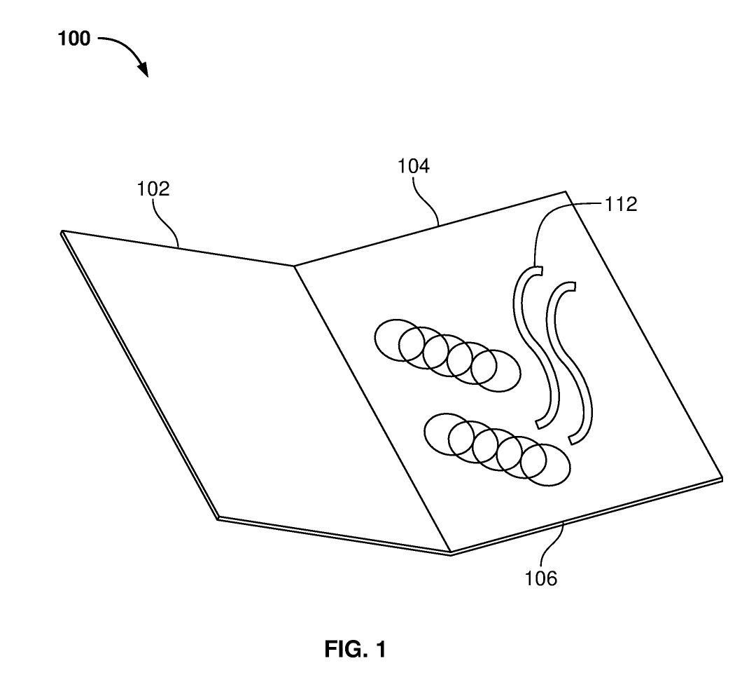

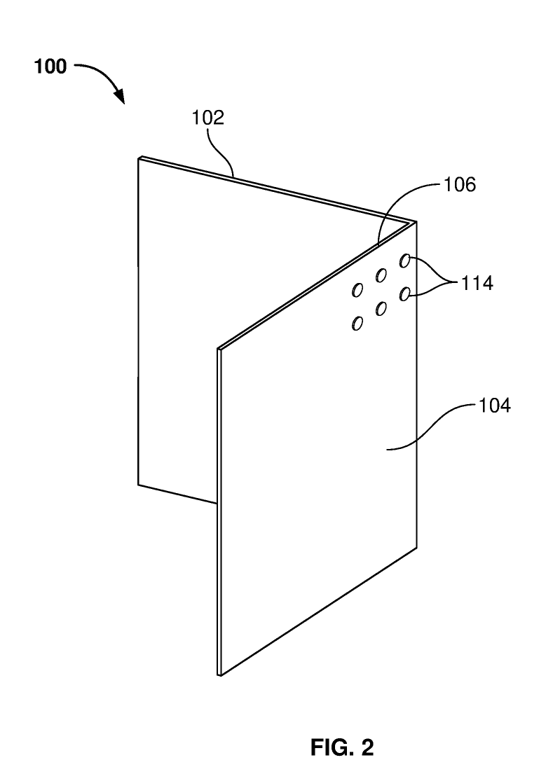

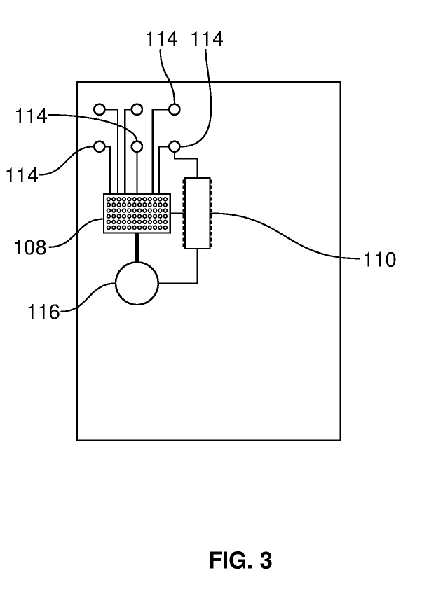

Referring now to FIG. 1, which shows a perspective view of the greeting card system 100. The greeting card system 100 comprises a planar sheet body of pre-defined shape comprising a first covering member 102 and a second covering member 104 fixedly attached to each other at their confronting ends, wherein the first covering member 102 is configured to scope for communicating a personalized message to the recipient. As shown in FIG. 2, the second covering member 104 defines a concealed section 106 wherein the concealed section 106 is configured to carry the plurality of audio files operably embedded in a microcontroller 110 to selectively play at least one audio file via an inbuilt speaker 108 as shown in FIG. 3. The inbuilt speaker 108 embedded in the concealed section 106 of the greeting card is selected from at least one of a micro speaker and a piezo speaker. The second covering member 104 is configured to provide a scope for communicating a personalized message to the recipient.

In an embodiment as shown in FIG. 2, according to the present invention, the greeting card system 100 comprises a plurality of switches 114 configured to selectively activate the microcontroller 110 embedded in the concealed section 106 of the second covering member 104 to play a sequence in relation with the illustrated artwork 112 on the second covering member 104 when a user opens the greeting card as shown in FIG. 1. The user is a recipient of the greeting card. The illustrated artwork 112 is selected from at least one of a decorative drawing, a mobile object and a textual design to enhance the artistic appearance of the greeting card. The switches 114 to activate the audio files and microcontroller 110 are selected from at least one of a push button and a sliding ball. However, other types of switches 114 are considered to be relevant within the scope of the present invention. These switches 114 are configured to be positioned near the right upper side of the concealed section 106 of the second covering member 104 of the greeting card such that a person who gives the greeting card to the recipient can selectively operate one of the switches 114 to play one embedded file. Once played, the audio file is locked into place with the illustrated artwork 112 that is depicted on the second covering member 104 of the greeting card to give an amazing experience for the recipients with lot of revelations. The greeting card system 100 may have different switches 114 giving the person a favorable condition to choose according to the circumstance to reveal the trick causing the desired pre-recorded audio file to play with the illustrated artwork 112. In different embodiments, the greeting card system is configured to have a set of six switches 114 defined to activate different sequence when the person who does the trick pushes it.

In an exemplary embodiment, the greeting card system 100 may take a flipbook configuration wherein the second covering member 104 is configured to display illustrated artwork 112 with text and multi file digital audio files positioned inside the concealed section 106 of the second covering member 104 to reveal different predictions for the trick shown to the recipient. In the present invention, the greeting card system 100 is configured to have at least five pre-recorded digital audio files embedded in the concealed section 106 of the second covering member 104 and played accordingly in relation with the illustrated artwork 112 and the text depicted on the second covering member 104 of the greeting card. In some embodiments, the illustrated artwork 112 may have mobile objects operably fixed on the second covering member 104 to get activated by the concealed motor section. Optionally, the greeting card system 100 may have a gear mechanism to activate the mobile object on the second covering member 104 whenever the person goes for the desired trick using the greeting card to provide a memorable event to the recipients. The microcontroller 110 stores all the data related to the playing sequence in a non-volatile memory such as EEPROM. So whenever the greeting card is opened for the recipient, the person who is doing the trick pushes the switch 114 on the back side of the second covering member 104 to reveal a trick that plays a sequence based on the data stored in the non-volatile memory of the microcontroller 110. In other embodiments, the electronics and further miniaturization for operating the greeting card system 100 may vary as the technology evolves and revisions of the same will be considered from time to time for effective functioning of the greeting card system 100.

According to the preferred embodiment as shown in FIG. 2, the greeting card system 100 is configured to have set of four different greeting cards to provide repeatable output with different outcomes each time when the recipient opens the greeting card. The greeting card is made in different sizes to fit a plurality of envelopes. The material for the greeting card is selected from at least one of a paper and a foam. However, other types of materials may be considered to be within the scope of the present invention without deviation. The greeting card system 100 as shown in FIG. 3 further comprises a power source 116 is coupled to the inbuilt speaker 108 and the microcontroller 110 embedded in the concealed section 106 of the second covering member 104 to activate a playing sequence. The power source 116 is selected from at least one of a portable battery unit and a remote power module.

In a preferred embodiment as shown in FIG. 3, the back side of the greeting card is illustrated. The person who is doing the trick just holds the upper right corner of the second covering member 104 in such a way that the index and the middle fingers comes in front side of the second covering member 104 and the thumb finger comes in back side of the greeting card. So the person can just push any of the switches 114 embedded on the upper right corner of the back side of the second covering member 104 when the greeting card is opened. Once the greeting card is opened, the microcontroller 110 inside the card is powered which in turn activates the playing sequence in relation with the predetermined illustrative artwork 112 on the second covering member 104. Therefore, the entire sequence right from the person pushing the switch 114 and activating the playing sequence is performed in a secret fashion which provides the recipient a visual treat. Further, the person who is doing the trick could change the playing sequence to a different mode by just simply pushing the next switch 114 randomly. So the recipient will not be able to make out how the trick is actually done

In an exemplary embodiment, the greeting card system 100 utilizes special effects with an accompanied audio file with numerous audio files to play the trick and it may also have moving pictures with integrated audio file delivering different messages to the recipient. The greeting card system 100 is utilized to serve plurality of events such as anniversary, sympathy, birthdays cards and so on. However, the set of four different greeting cards configured to provide various outcomes to mark the occasion and to amaze the recipient.

The greeting card system 100, according to the present invention, is interactive so that it does an amazing magic trick for the recipient. These greeting cards reads the recipient's minds and the person can show them a vanishing trick giving visual treats to the recipients. The recipient of these greeting cards does not feel boredom as they are treated with different outcomes by the greeting card at each instance. This enables the recipients to celebrate their event with more entertainment and even more memorable for longer period of time. The greeting card system 100 empowers the quality of greeting someone and provides a new dimension in celebrating any occasion. The recipients of these greeting cards are treated with magical revelations which would keep them guessing and interactive with the greeting card system 100.

Although the present invention has been described herein in the context of a particular implementation in a particular environment for a particular purpose, those of ordinary skill in the art will recognize that its usefulness is not limited thereto and that the present invention may be beneficially implemented in any number of environments for any number of purposes. Accordingly, the claims set forth below should be construed in view of the full breadth and spirit of the present invention as described herein.

I claim:

1. A greeting card system comprising:
a planar sheet body of pre-defined shape comprising a first covering member and a second covering member fixedly attached to each other at their confronting ends, wherein the first covering member is configured to provide a scope for communicating a personalized message to the recipient;
wherein the second covering member defines a concealed section comprising,
a plurality of audio files is operably embedded in a microcontroller in the concealed section to selectively play at least one audio file via an inbuilt speaker;
a plurality of switches, wherein each of the plurality of switches selectively activates the microcontroller, wherein the microcontroller is selectively activated to play at least one sequence based on the predetermined illustrative artwork on the second covering member, and wherein each of the at least one sequences have a different outcome.

2. The greeting card system of claim 1, wherein the card is made in different sizes to fit a plurality of envelopes.

3. The greeting card system of claim 2, wherein the material for the card is a foam.

4. The greeting card system of claim 3, wherein the second covering member comprises at least five audio files embedded in the concealed section to selectively receive via the plurality of switches.

5. The greeting card system of claim 4, wherein the inbuilt speaker is selected from at least one of a micro speaker and a piezo speaker.

6. The greeting card system of claim 5, wherein the microcontroller comprises a non-volatile memory to store the data required to play the at least one sequence.

7. The greeting card system of claim 6, wherein each of the plurality of switches to activate the audio files and microcontroller is a sliding ball.

8. The greeting card system of claim 1, wherein the audio file is a pre-recorded audio clip.

9. The greeting card system of claim 7, wherein the pre-recorded audio clip embedded in the concealed section of the second covering member is relates to the predetermined illustrated artwork on the second covering member of the greeting card.

10. The greeting card system of claim 9, comprises at least four different greeting cards configured to provide the different outcomes of the at least one sequence.

11. The greeting card system of claim 9, wherein a power source is coupled to the inbuilt speaker and the microcontroller embedded in the concealed section of the second covering member to activate a playing sequence.

12. The greeting card system of claim 11, wherein at least one switch of the plurality of switches is disposed within the upper corner of the second covering member, wherein the sequence is initiated, and wherein a second sequence is initiated when another of the plurality of switches is activated.
